(19) United States
(12) Patent Application Publication
(10) Pub. No.: US 2017/0291831 A1
(43) Pub. Date: Oct. 12, 2017

(54) UV REFLECTIVE SYSTEM INCLUDING A THIN PLASTIC COATED ALUMINUM REFLECTOR OR A THIN PLASTIC REMOVABLE BLADDER

(71) Applicant: Hydro-Photon, Inc., Ellsworth, ME (US)

(72) Inventors: Miles Maiden, Blue Hill, ME (US); Aaron M. Cox, Ellsworth, ME (US); Karen C. Milliken, East Blue Hill, ME (US)

(21) Appl. No.: 15/478,572

(22) Filed: Apr. 4, 2017

Related U.S. Application Data
(60) Provisional application No. 62/319,064, filed on Apr. 6, 2016.

(51) Int. Cl. C02F 1/32

(52) U.S. Cl. CPC C02F 1/325; C02F 2303/04; C02F 2201/3228; C02F 2201/3222; C02F 2201/009

(57) ABSTRACT

A water purification system includes one or more UV light sources that produce germicidal UV light and provide the UV light to a given amount of fluid contained in a chamber as a batch or as flowing through the chamber. An inner surface of the chamber, that may be reflective, is coated with a thin plastic film, such as polypropylene, that is highly transmissive to UV germicidal light. The thin plastic film separates the inner surface from the fluid, and the UV light passes through the thin plastic film to reach the fluid that is being purified in the chamber. The thin plastic film may be melted at relatively low temperatures to provide heat sealing of the surface to produce the chamber. Alternatively, the thin plastic film may be readily shaped as a bag or pipe that contains or directs fluid flow.

### CROSS-REFERENCE TO RELATED APPLICATIONS

The present application claims the benefit of U.S. Provisional Patent Application Ser. No. 62/319,064, which was filed on Apr. 6, 2016, by Miles Maiden et al. for UV REFLECTIVE SYSTEM INCLUDING A THIN PLASTIC COATED ALUMINUM REFLECTOR OR A THIN PLASTIC REMOVABLE BLADDER, which is hereby incorporated by reference.

The present application is related to the following U.S. Provisional Patent Application Ser. No. 61/868,235, which was filed on Aug. 21, 2013, by Miles Maiden for a PORTABLE WATER PURIFICATION SYSTEM USING ONE OR MORE LOW OUTPUT POWER UV LIGHT SOURCES; U.S. Provisional Patent Application Ser. No. 61/922,172, which was filed on Dec. 31, 2013, by Miles Maiden for a PORTABLE WATER PURIFICATION SYSTEM USING ONE OR MORE LOW OUTPUT POWER UV LIGHT SOURCES AND UV SENSORS; U.S. Provisional Patent Application Ser. No. 61/987,194 which was filed on May 1, 2014, by Miles Maiden for a FLOW-THROUGH UV WATER PURIFICATION SYSTEM WITH HIGHLY REFLECTIVE INSERT; and U.S. patent application Ser. No. 14/461,562, which was filed on Aug. 18, 2014, by Miles Maiden for a PORTABLE WATER PURIFICATION SYSTEM USING ONE OR MORE LOW OUTPUT POWER UV LIGHT SOURCES, all of which are hereby incorporated by reference.

### FIELD OF THE INVENTION

The invention relates generally to portable water purification systems and, more particularly, to portable water purification system utilizing a thin plastic coated aluminum reflector or a thin plastic removable bladder.

### BACKGROUND INFORMATION

Portable water purification systems that disinfect small quantities, or batches, of water using germicidal ultraviolet (UV) light, that is, UV light in the germicidal range, are well known and highly popular. U.S. Pat. Nos. 5,900,212, 7,641,790 and 8,226,831 are examples of such systems. The systems work well, using UV lamps or UV LEDs that provide UVC light to water held within bladders, bottles and so forth. The UV lamps are relatively inefficient, however, operating to produce in the water UVC light with an output power that is approximately 30% of the input power supplied to the UV lamp. The power source may be, for example, an external power outlet, batteries, solar power strips, photovoltaic fabric, and so forth and/or various combinations thereof. The portable water purification systems may be used by campers, hikers, travelers, and/or people living in areas in which replacement batteries are hard to come by and/or utilities are limited or unavailable. Accordingly, it is desired to provide a portable water purification system that operates more efficiently in terms of required power, to avoid running down batteries and/or requiring higher solar power generation, and so forth, in order to minimize the time the system is down because of a lack of input power. A more efficient system would also reduce the need for the user to carry or attempt to locate replacement batteries and/or reduce the cost and complexity of the solar power generator by requiring less capacity. A more efficient system would also require fewer or smaller UV light sources thereby further reducing system cost.

### SUMMARY OF THE INVENTION

A portable water purification system includes one or more UV light sources that produce germicidal UV light and provide the UV light to a given amount of fluid contained in a chamber as a batch or as flowing through the chamber in which a thin plastic film, that may be polypropylene (PP) of a thickness of 0.003 of an inch or less that is highly transmissive to UV germicidal light, separates a reflective inner surface of the chamber from the fluid. The thin plastic film ensures that the fluid is not contaminated by the reflective inner surface and also that the reflectance of the inner surface is not adversely affected by the fluid, such as fluid retained in the chamber over time. The thin plastic film may be a coating on the reflective inner surface, and in a system in which the surface is made of aluminum, the thin plastic film may be melted at relatively low temperatures to provide heat sealing of the surface to produce the chamber. Alternatively, the thin plastic film may be readily shaped as a bag or pipe that contains or directs fluid flow.

Utilization of plastic as the coating on the reflective inner surface over other highly UV-transmissive materials, such as Teflon, is more cost effective. In addition, plastic has a lower melting point than that of other highly UV-transmissive materials, such as Teflon. As such, heat sealing the thin plastic bag and the thin plastic removable bladder (e.g., sealing two ends of the plastic together) is easier and more efficient than heat sealing Teflon.

### BRIEF DESCRIPTION OF THE DRAWINGS

The invention description below refers to the accompanying drawings, of which:

FIG. 1 is a cross-sectional view of a system constructed in accordance with the invention;

FIG. 2 is a cross-sectional view of an alternate arrangement of a system constructed in accordance with the invention;

FIG. 3 is a cross-sectional view of an alternate arrangement of a system constructed in accordance with the invention;

FIG. 4 is a flow-chart of the operation of the systems of FIGS. 1-3;

FIG. 5 is a cross-sectional view of an alternate arrangement of a system constructed in accordance with the invention;

FIG. 6 is a cross-sectional view of an alternate arrangement of a system constructed in accordance with the invention;

FIG. 7 is a cross-sectional view of an alternate arrangement of a system constructed in accordance with the invention;

FIGS. 8A and 8B are cross-sectional views of alternative arrangements of the UV light sources in the systems of FIGS. 1-3;

FIGS. 9 and 10 are cross-sectional views of alternative flow-through arrangements of a system constructed in accordance with the invention;

FIGS. 11 and 12 are cross-sectional views of a removable bladder that may be included in the systems of FIGS. 1-3 and 5-7;

FIG. 13 is a cross-sectional view of a flow-through arrangement with a highly reflective insert;

FIG. 14 illustrates the arrangement of FIG. 13 with removable end caps;

FIG. 15 illustrates the arrangement of FIG. 13 with an inflatable insert; and

FIG. 16 illustrates a flow-through arrangement with a removable reflective chamber.

### DETAILED DESCRIPTION OF AN ILLUSTRATIVE EMBODIMENT

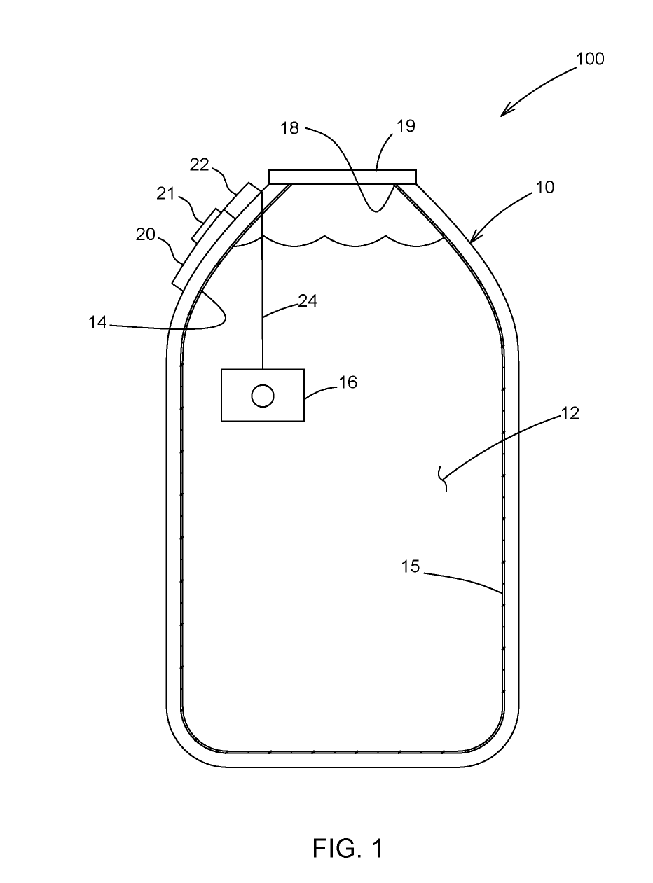

Referring now to FIG. 1, a system 100 includes a bladder 10 that has an amplifying chamber 12 for receiving a fluid to be purified. The amplifying chamber 12 has an inner surface 14 that is highly reflective of germicidal UV light. The amplifying chamber 12 further has an opening 18 that serves both as an inlet for the fluid to enter the amplifying chamber 12 and an outlet for the fluid to exit the amplifying chamber 12. A cover 19, which may, but need not, have a UV reflective inner surface, preferably closes the opening 18, to enclose the fluid as a batch prior to operation of one or more UV light sources 16 to produce the germicidal UV light. A power source 20 drives the one or more UV light sources 16 to provide to the batch of fluid contained in the amplifying chamber 12 a small fraction of the total UV energy that is required to purify the amount of fluid in the batch contained in the chamber 12. The highly reflective inner surface 14 of the amplifying chamber 12 repeatedly re-directs the UV light that reaches the inner surface 14 back through the fluid simultaneously and in essentially all directions, resulting in the purification of the contained fluid.

The highly reflective inner surface 14 may, for example, be made of polished aluminum, which has a reflectance of approximately 98% for the germicidal UV light. Any material that has reflectance at or above 60%, and preferably at or above 70%, for the germicidal UV light may be utilized for the highly reflective inner surface 14.

The highly reflective inner surface 14 may be coated with a thin plastic film 15 that is highly UV-transmissive. The thin plastic film 15 keeps the reflective inner surface 14 free of oxidation and prevents the water in the chamber 12 from being exposed to the aluminum properties of the inner surface 14 that could potentially contaminate the water, and also ensures that the reflectance of the reflective inner surface 14 is not adversely affected by the fluid, such as fluid retained in the chamber over time.

For example, the thin plastic film 15 may be polypropylene (PP), such as oriented (OPP) or cast (CPP). To ensure that the thin plastic film is highly UV-transmissive, the thin plastic film 15 has a thickness of around 0.003 of an inch. In an embodiment, the thickness of the thin plastic film 15 is less than or equal to 0.003 of an inch. In an embodiment, the thin polypropylene film that is UV-transmissive in the range of 230 to 300 nanometers. Because the thin plastic film 15 is highly UV-transmissive, the thin plastic film 15 provides minimal interference to the UV light from the UV light sources 16 through the fluid and to and from the highly reflective inner surface 14 that repeatedly redirects the UV light to purify the fluid. In addition, the thin plastic film 15 allows the aluminum to be heat sealed, as appropriate, to produce the amplifying chamber 12, since the melting point of the PP is relatively low.

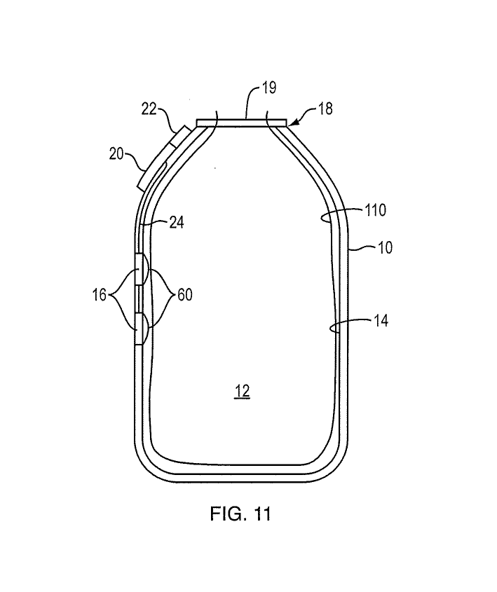

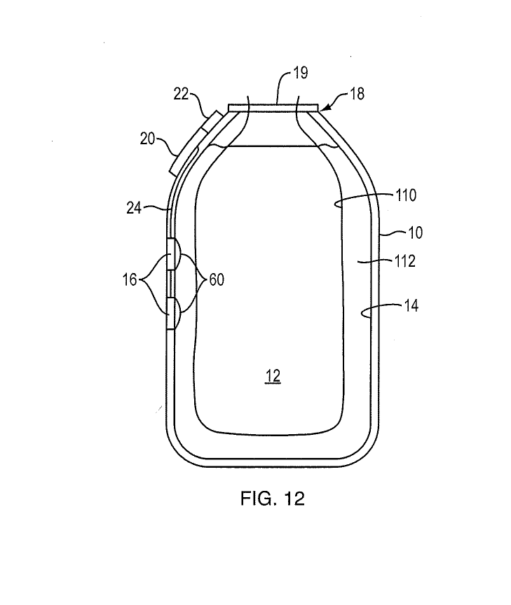

Alternatively, and as described with respect to FIGS. 11-12, a highly UV transmissive thin plastic removable bladder 110 made, for example, from PP, may be housed in or removably added to the amplifying chamber 12 to hold the fluid.

The system 100 may include a user-operated switch 21 or a water sensor enabled/activated switch (not shown) to turn on the one or more UV light sources 16. The user operated switch 21 may be located on the power source 20, as shown in the drawing, or located on the cover 19 or on the bladder 10. Alternatively, the cover 19 may act as a switch, such that a circuit that connects the power source 20 to the one or more UV light sources 16 is completed when the cover 19 is in place to close the opening 18. Optionally, a timer 22 may be utilized to turn the one or more UV light sources 16 off a predetermined time after they are turned on.

The one or more UV light sources 16 are positioned within the amplifying chamber 12 to not only direct UV light into the fluid contained in the chamber 12, but also to minimize the blocking of UV light that is repeatedly redirected through the fluid simultaneously from essentially all directions by the reflective inner surface 14. As discussed in more detail below, the system 100 drives the one or more UV light sources 16 to produce only a small fraction of the total UV energy that is required to purify the given amount of fluid contained in the amplifying chamber 12. The amplifying chamber 12, by repeatedly redirecting the UV light that reaches the reflective inner surface 14 back into the batch of fluid, facilitates the purification of the fluid. Thus, the power source 20 of system 100 need produce only a correspondingly small fraction of the input power and/or operate over a shorter time period than would otherwise be required if the batch of fluid were contained, for example, in a conventional bladder chamber.

As depicted in FIG. 1, the one or more UV light 16 sources are suspended in a desired position within the amplifying chamber 12, essentially in the center of the amplifying chamber 12, to extend into the fluid contained in the chamber 12 and essentially minimize the blocking of the paths of light to and from the reflective inner surface 14. The one or more UV light sources 16 may be permanently positioned within the chamber 12, for example, suspended from a wall of the chamber 12 by a tether 24 that extends through the wall to connect to the power source 20. The one or more UV light sources 16 may instead be positioned within the chamber 12 for purification of the batch of fluid and thereafter removed from the chamber 12.

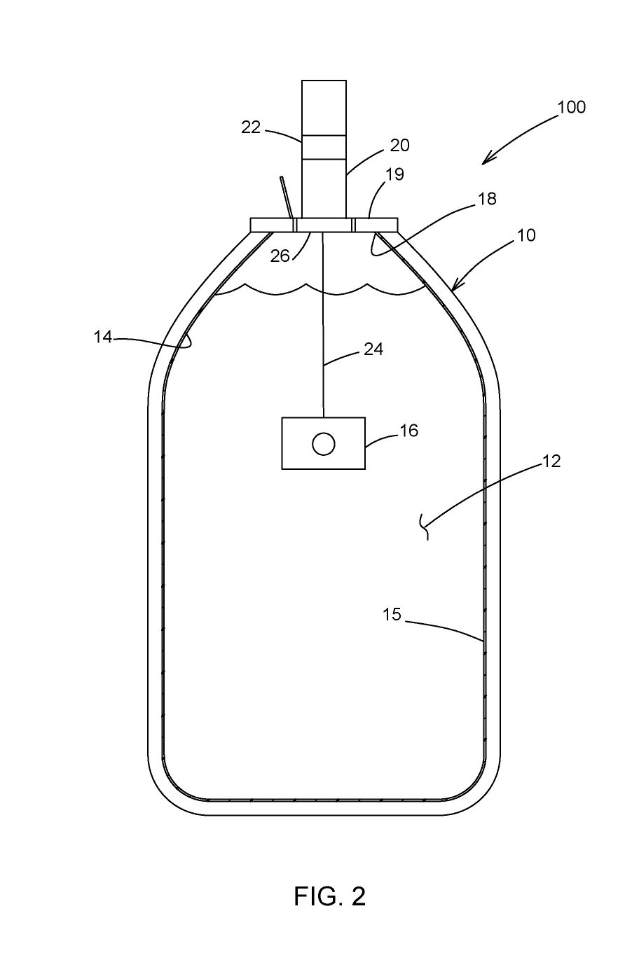

As depicted in FIG. 2, the one or more UV light sources 16 may be provided to the chamber 12 through a re-closable passageway 26 in the cover 19, or alternatively, through a re-closable passageway (not shown) in the chamber wall. If the one or more UV light sources 16 are removable, a fluid level sensor (not shown) may be included in the system for safety reasons, to ensure that the one or more UV light sources 16 do not turn on or stay on unless they are submerged in the fluid.

Typically, UV lamps and UVC LEDs have estimated efficiencies of approximately 30% and 2%, respectively. Accordingly, the UV lamp must be driven by an input power of approximately 3.3 times the output power that is required in the fluid, while the UV LEDs must be provided approximately 50 times the required output power.

The UV energy required to purify a batch of fluid is within the range of 15 mJ/cm² to 50 mJ/cm². The National Sanitation Foundation defines a dose required for microbiological water purification as 40 mJ/cm². As an example, a purifying dose of UV energy of approximately 50 mJ/cm² provided by a UV lamp to a liter of water held in a conventional bladder, i.e., a bladder without the amplifying chamber 12, requires the UV lamp to deliver about 153 Joules or 1.7 W for 90 seconds to the water, assuming some agitation of the water. The input power supplied to the UV lamp, assuming the 30% efficiency discussed above, is 5 W for 90 seconds. Testing of the fluid after the dosing confirms that the fluid is well over 99% free of the microbes. Two UV-C LEDs driven by an input power of 1.25 W for 90 seconds deliver only approximately 2 Joules or 0.02 W for 90 seconds into the liter of water. Accordingly, the two UV-C LEDs driven in this manner cannot provide the required dose of UV light to purify the 1 liter of water contained in a conventional bladder. To provide the required dosage at the stated input power level, and based on the assumed efficiency of 2%, the input power to drive the UV LEDs operating in a conventional bladder is on the order of 85 W.

Using the system 100, however, the two UV-C LEDs operating in the amplifying chamber 12, with the highly reflective inner surface 14 that repeatedly redirects back through the water the UV light that reaches the reflective surface, may be driven by the 1.25 W input power for 90 seconds and successfully purify the 1 liter of water. Testing reveals that the dosed water achieves essentially the same level of purification as was achieved by the UV lamp providing 153 Joules to water contained in a conventional bladder. Accordingly, using the system 100, the two UV LEDs deliver to the 1 liter of water contained in the amplifying chamber 12 approximately 1.3% of the power delivered by the UV lamp to a liter of water held in a conventional bladder, and yet the system 100 treats the contained water to the level of purification associated with a UV energy of 50 mJ/cm². Thus, the system 100 produces the desired purification with roughly just 25% of the input power required to drive one or more UV light sources 16 in a conventional bladder and approximately just 1.3% of the UV energy required for desired purification in a conventional bladder.

The system 100 may operate the one or more UV light sources 16 to deliver to the 1 liter of water approximately 20 mW for 90 to 120 seconds, to purify 1 liter of water held as a batch in the amplifying chamber 12. The system 100 may thus operate efficiently with a small number of UV LEDs, for example, 1 or 2 UV-C LEDs, with the power source 20 providing an input power of a small number of milliwatts, in the example 50 mW, to drive the UV LEDs. Alternatively, the system 100 may operate a UV lamp at a similarly reduced output power, with the power source 20 similarly providing input power to the UV lamp in milliwatts or as a small number of watts, such as, for example, 10 watts.

The system 100 drives the one or more UV light sources 16 to provide, to the fluid in the amplifying chamber 12, a fraction of the total UV energy that is required to purify a given amount of fluid contained in the amplifying chamber. The fraction may be equal to or below 30%, depending on the reflectance of the highly reflective inner surface 14. In the example, in which the highly reflective inner surface 14 is polished aluminum with a reflectance at or near 98% for the germicidal UV light, the fraction is at or near 1%. Using another material or a less polished aluminum surface that has a reflectance which may be closer to 70%, the fraction may be closer to 30%.

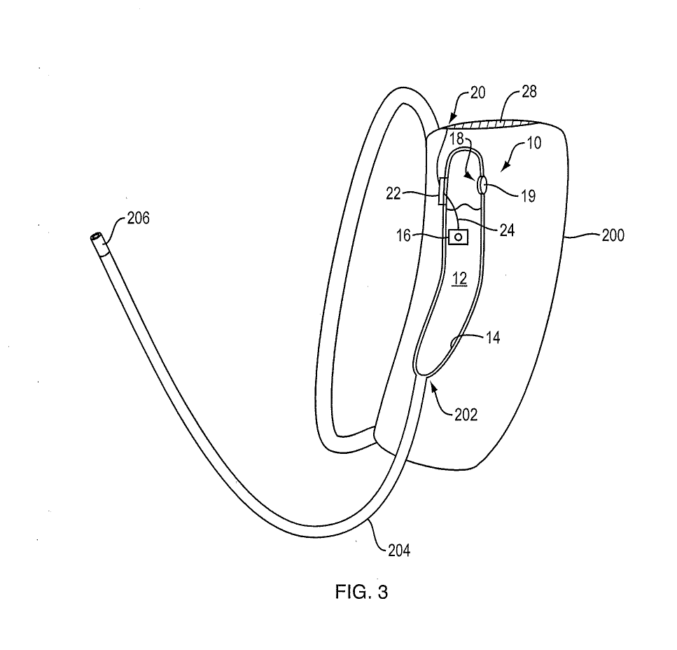

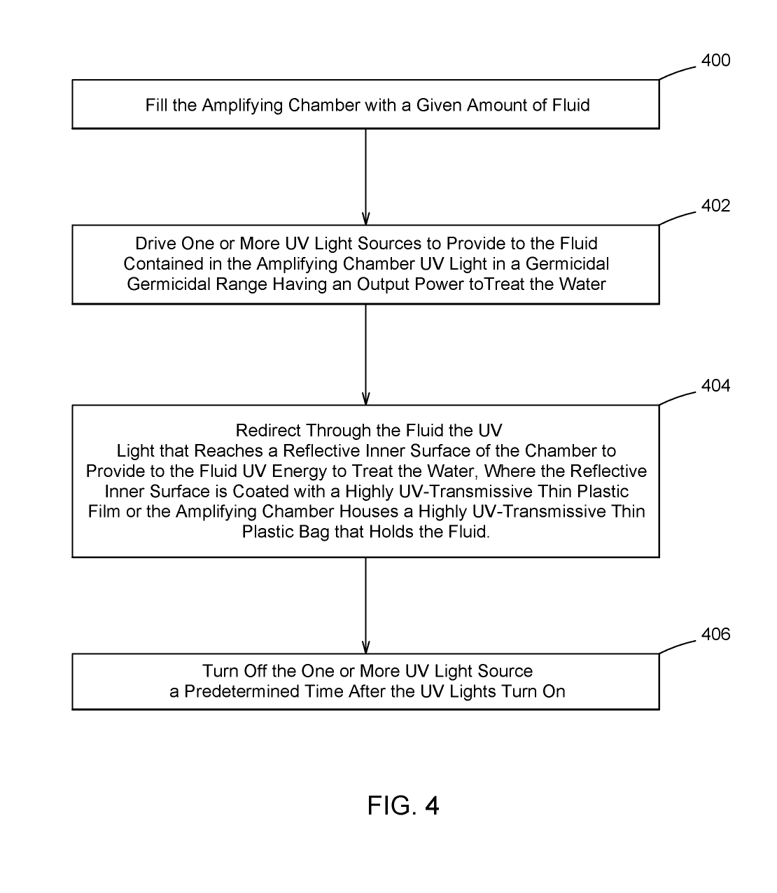

The system 100, which may operate with reduced input power, may thus operate efficiently using solar power. Referring now also to FIGS. 3 and 4, the power source 20 may consist of one or more solar power strips or, as shown, a photovoltaic fabric 28. The solar power strips or photovoltaic fabric 28 may be incorporated into a backpack 200 that carries the bladder 10. The bladder 10 incorporated into the backpack 200 provides a valve-controlled outlet 202 from the amplifying chamber 12 so that a user can have intermittent access to the purified fluid. A user may thus access the purified fluid through a line and valves 204, 206 in a known manner. The system 100 may include a display (not shown) that informs a user that the fluid contained in the bladder 10 is purified. Alternatively, the system may block access to the fluid via the valve and line unless the fluid contained in the bladder 10 is purified.

To use the system 100 contained in the back pack 200, a user fills the amplifying chamber 12 of the bladder 10 with a given amount of fluid through the inlet 18 (step 400) and turns on the system 100. The system operates to purify the contained fluid when, for example, the required watts or milliwatts of input power are available from the solar-powered power source 20. The system drives the one or more UV light sources 16 with an input power that corresponds to an output power to treat the water. For example, the output power is a fraction of the UV output power required to purify the batch of fluid contained in the amplifying chamber 12 (step 402). The reflective inner surface 14 of the amplifying chamber 12 may be made of aluminum and coated with a highly UV-transmissive thin plastic film, such as PP. Alternatively, the amplifying chamber 12 may house a highly UV-transmissive thin plastic removable bladder 110 (as shown in FIGS. 11 and 12) made from PP that holds the water and separates the water from the aluminum surface. The reflective inner surface 14 redirects the UV light that reaches the inner surface into the batch of fluid simultaneously in all directions, to purify the fluid (step 404), such that the UV light repeatedly passes through the highly UV-transmissive plastic film 15 or the highly UV transmissive thin plastic removable bladder 110, to treat the water. To ensure that the thin plastic removable bladder 110 is highly UV-transmissive, the thin plastic removable bladder 110 has a thickness of around 0.003 of an inch. In an embodiment, the thickness of the thin plastic removable bladder 110 is less than or equal to 0.003 of an inch.

The system or the user then turns off the one or more UV light sources 16, for example, a predetermined time after the light source 16 turns on (step 406).

The bladder 10 may be, but is not necessarily, flexible. The reflective inner surface 14 of the chamber 12 may be creased as the bladder 10 flexes or may be creased otherwise, without adversely affecting the operation of the system.

All or a portion of the bladder material, which is non-transmissive to UVC light, may be transmissive to visible light, so that a user can see how much water is in the bladder 10 and determine, for example, when to re-fill the bladder 10 to the fill line and operate the system. The reflective bladder 10 may be designed to be disposable and thus a user may replace the bladder 10 in order to ensure a high level of UV reflectance is maintained over time and multiple uses.

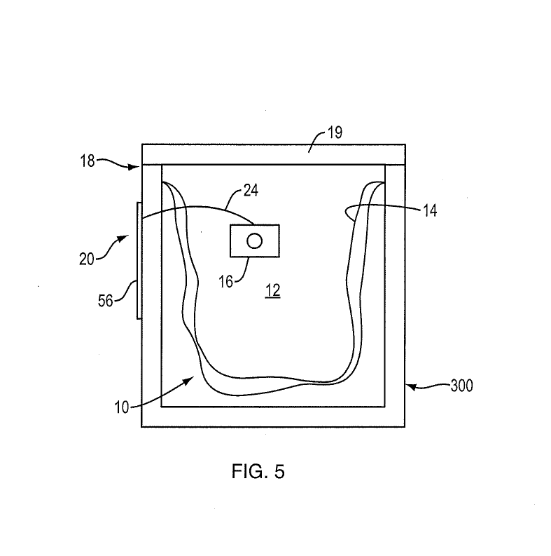

Referring now to FIG. 5, the bladder 10 may be contained within a flexible or rigid bottle 300. As discussed above, the bladder 10 may, but need not, be flexible within the bottle and the inner reflective surface 14 of the amplifying chamber 12 may be creased without adversely affecting the operation of the system. The rigid container 300 may support one or more solar power strips 56 that provide the power needed to drive the one or more UV light sources 16.

The power source 20 may consist of one or more batteries (not shown), which may be, for example, re-charged by solar power or re-charged through an external outlet. Alternatively, the power source 20 may be a super capacitor (not shown) that is charged by solar power or an external outlet. The capacitor may be sized for a full dose of the UV energy required to purify the fluid, or the capacitor may instead be recharged multiple times, to repeatedly drive the one or more UV light sources 16 to provide the UV energy to the amplifying chamber 12 in a number of installments. A microprocessor (not shown) may be included in the system 100, to determine when the UV energy required by the system 100 is provided through the installments. As discussed, the power to drive the UV light sources 16 may instead be provided by various external sources, such as an electrical outlet, fuel cells, a crank dynamo, and so forth.

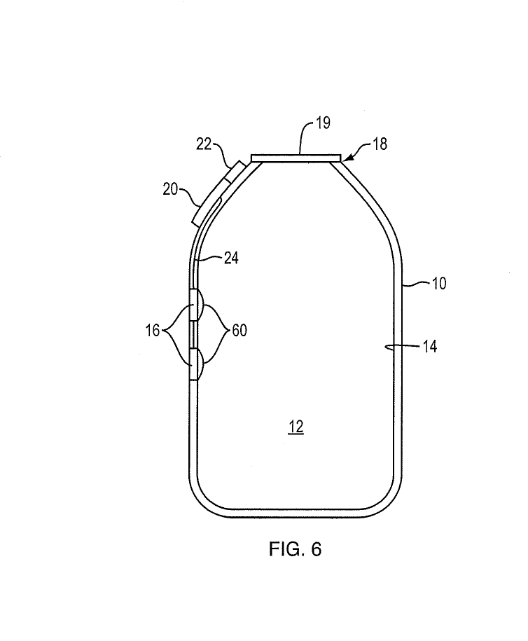

As shown in FIG. 6, the one or more UV light sources 16 may instead be imbedded in or attached to the wall of the amplifying chamber 12, with surfaces 60 of the light sources 16 directing the UV light into the fluid contained in the amplifying chamber 12 from the chamber wall. Notably, the surfaces 60 of the one or more UV light sources 16 consume only a relatively small portion of the reflective inner surface 14, and thus, the surfaces 60 do not adversely affect the operation of the system. Alternatively, the one or more UV light sources 16 may reside behind one or more correspondingly sized UV transparent windows (not shown) in the chamber wall. If the UV source is positioned in the water, the water may act as a heat sink thereby eliminating the need for large external heat sinks to be added to the system. Additionally, surface areas of the UV source that do not emit UV light may be covered in UV reflective material in order to enhance system performance.

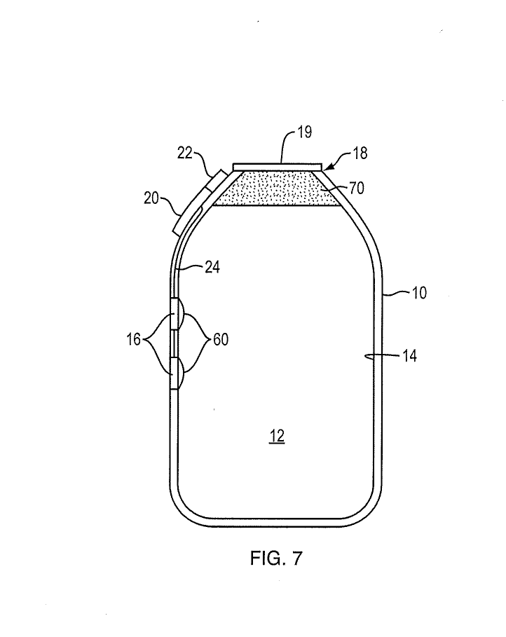

As shown in FIG. 7, the system 100 may include a filter 70 that prefilters the water flowing into the bladder 10, to remove larger microbes and/or reduce turbidity. The filter 70 may be a part of the bladder 10 or may be removed from the bladder 10 after use. The filter 70 may be, for example, the filter described in U.S. Pat. No. 8,197,771.

As discussed, the cover 19 may, but need not, include an inner surface that is reflective of the UV light. Further, since an air/fluid boundary inhibits the passing of UV light out of the fluid, the inner reflective surface 14 may extend only slightly above a predetermined maximum fluid level in the amplifying chamber 12 and a non-reflective inner surface (not shown) may extend above the fluid line, without adversely affecting the operation of the system. Alternatively, the reflective inner surface 14 may extend over the entirety of the interior of amplifying chamber 12. Also, the fluid fill line may be at or near the top of the amplifying chamber, to ensure that the batch of fluid to be purified essentially fills the chamber.

The power source 20 may operate using pulse width modulation or may operate as a continuously on source. The amplifying chamber 12 may have a capacity that is larger than 1 liter, for example, 1 gallon or 5 gallons, and the power source 20 drives the one or more UV light sources 16 at a corresponding higher input power, for example, a large number of milliwatts, and/or for a longer period of time such as 240 or more seconds. At times, the amplifying chamber 12 may be filled with less than the rated capacity of fluid and the user, manually, or the system, automatically, may change the dose duration accordingly.

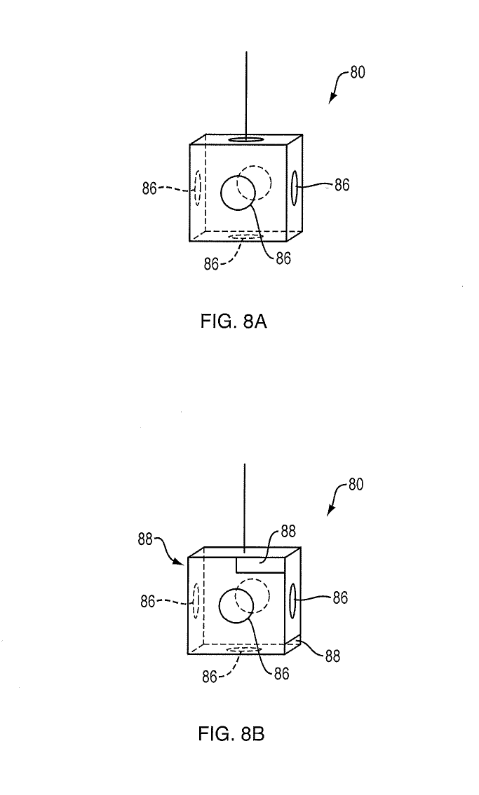

It may be desirable to measure the intensity of the UV light in the amplifying chamber 12, to ensure proper dosage during a purification operation. Referring now to FIG. 8A, multiple UV LEDs 86 may be arranged in a cluster 80, in which the respective UV LED light sources face in various directions. One or more of the UV LEDs 86 operate in dual modes, in a first mode the UV LED operates as a source of UV light and in a second mode the UV LED operates as a UV light sensor. Operating in the first mode, the UV LED emits UV light in response to a supplied voltage, as is conventional. Operating in the second mode, the given UV LED performs essentially as a photodiode and, in response to the receipt of UV light, produces a current that varies with the intensity of the UV light.

During a purification operation, the one or more dual mode UV LEDs operate as UV sensors at selected times for short periods of time, such as 1 millisecond out of each 1 second of operation and operate as UV light emitters for the remainder of each second either in continuous mode (CW mode) or in pulse width modulation mode. For example, the system may operate one UV LED facing in a given direction as a UV sensor for a first millisecond and, as appropriate, operate a second UV LED facing in a different direction as a UV sensor for a next millisecond and so forth. The system measures the current produced by the one or more dual-mode UV LEDs and determines the intensity of the UV light within the chamber 12 based on the measurements. When multiple UV LEDs are operated as UV sensors, the associated intensity readings may be averaged to determine the intensity of the UV light in the amplifying chamber 12.

As discussed, the intensity of the UV light in the amplifying chamber 12 is essentially uniform, and therefore, the intensity can be measured anywhere within the chamber 12. This is in contrast to known prior systems in which the intensity of the UV light is measured at the farthest distance of the fluid from the UV light source, in order to measure essentially a worst case dosage amount.

Referring to FIG. 8B, an alternative arrangement of the cluster 80 includes one or more dedicated photosensors 88, such as PIN diodes or phototransistors, interspersed with the UV LEDs 86. In this arrangement, the UV LEDs 86 operate as conventional light emitters all of the time and the photosensors operate to measure the intensity of the UV light in the chamber 12. If more than one photo sensor is utilized, the photosensors are arranged in various orientations around the cluster, to sense the UV light from different directions. Alternatively, the UV sensors may be located at other sites within the chamber 12. However, an advantage to locating the sensors in the cluster is that the associated electronics for the UV LEDs and the UV sensors are co-located.

In any of the arrangements of the UV LEDs, dual-mode UV LEDs and/or UV sensors, readings of the intensity of the UV light are provided with respect to one or more directions within the amplifying chamber. The intensity values may be averaged if readings from more than one direction are available. The readings are then compared with a known required UV energy level for purification and, as appropriate, the purification operation may be extended for a period time to ensure a proper dosage. In circumstances in which the sensor readings indicate a UV intensity level below a predetermined threshold, which may occur, for example, when the contained fluid has a relatively high level of particulates, the system discontinues the purification operation and notifies the user of the early termination.

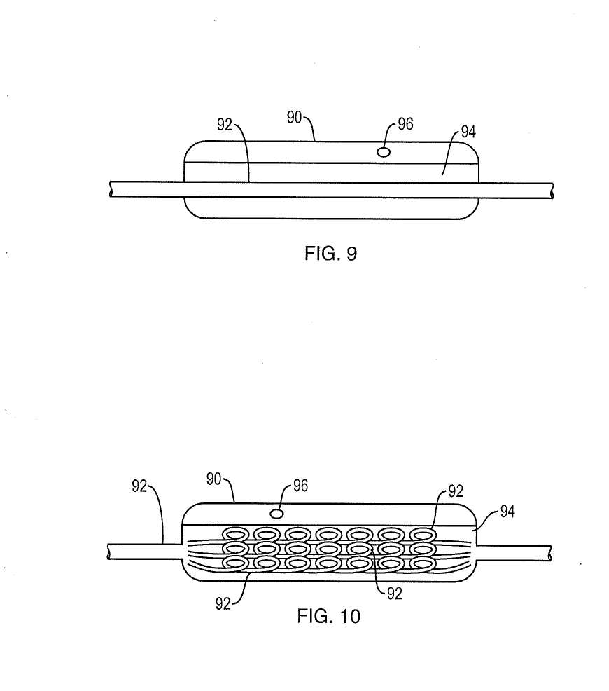

Referring to FIG. 9, in alternative embodiment a flow-through amplifying chamber 90 includes one or more tubes 92 (one shown) that provide pathways through which the liquid that is being treated flows through the chamber 90. The tubes 92, which are thin-walled and have relatively small diameters, are made of material that is both transmissive to UV light and has an optical density or index of refraction that is similar to the liquid being treated. In the example, the liquid is water and the tubes 92 are made of a thin plastic film (not shown), such as PP, that is highly UV-transmissive, as described above.

The tubes 92 may run through a standing reservoir 94 that contains liquid that is essentially of the same type as the liquid that is being treated, in the example, water. Thus, the reservoir 94 may contain untreated water, treated water, distilled water and so forth. The reservoir 94 extends the length of the chamber 90 and is sufficiently deep to cover the tubes 92 with liquid. The UV light provided to the chamber 90 by one or more UV light sources, in the example, UV LEDs 96 (one shown), is reflected into the reservoir 94 in all directions by the walls of the flow-through amplifying chamber 90, in the manner described above. The tubes 92, which have similar indices of refraction as the liquid in the reservoir 94, essentially disappear in the liquid since the boundaries of the tubes 92 and the liquid in the reservoir 94 do not reflect the UV light back into the reservoir 94, regardless of the incident angle of the UV light on the tubing 92. The UV light instead passes through the tubes 92 and into the water that is flowing within the tubes 92 in all directions.

The required UV treatment dose dictates the time that the water must remain within the chamber 90, and thus, the tubing 92 is sized appropriately to ensure treatment. Each tube 92 is also sized and shaped (i.e. wound in a spiral) to ensure that all of the water flowing through the tube 92 flows at essentially the same rate, and thus, receives the same level of UV treatment. As discussed, the tubes 92 have relatively small diameters, with lengths dictated by the required time for treatment at a given liquid pressure.

Referring also to FIG. 10, the tubes 92 may be coiled, to provide longer paths through the flow-through amplifying chamber 90. Thus, the flow-through amplifying chamber 90 may be made correspondingly shorter, without adversely affecting the treatment of the water.

In the example, the reservoir 94 is filled with water, and the water in the reservoir 94 is thus treated in a batch mode by the UV light within the flow-through amplifying chamber 90. Accordingly, after one or more treatment cycles, the water in the reservoir 94 may be used for any purpose such as drinking, cooking, and so forth. Thus, the reservoir 94 may be filled with non-purified water at the start of an initial treatment cycle and, as appropriate, may remain filled with the same (now treated) water for multiple treatment cycles. Alternatively, the reservoir 94 may be initially filled with distilled water, as appropriate, which better matches the refractive index of the thin plastic used for the tubing 92.

In a similar sized system or a larger scale system (not shown), the chamber 90 may but need not be reflective. The tubing 92 operates in the same manner, to direct the flow of the liquid to be treated through the chamber 90, within a standing reservoir 94 of liquid, here water, held in a chamber 90. As discussed, the required UV dosage dictates the amount of time the water must remain in the chamber 90, and the UV transmissive thin plastic tubing 92, which essentially disappears in the water, is sized and shaped to ensure that all of the water flowing through the chamber 90 is treated with essentially the same amount of UV light. If the chamber 90 is not reflective, the time required for treatment will be longer and the flow rate must be slower and/or the path defined by the tubing 92 must be sufficiently long to ensure the liquid remains in the chamber 90 for the required dose.

As discussed, the tubing 92 prevents unequal treatment of the flowing liquid, in the example, water. In conventional large or even smaller scale flow through systems, some of the liquid to be treated typically proceeds rapidly through the flow-through chamber 90 while other liquid enters the chamber 90 and is essentially pushed aside, and thus, proceeds more slowly through the chamber 90. The tubing 92 prevents such uneven flow through the chamber 90 and the submersion of the tubing 92 in the reservoir 94 prevents reflection of the UV light that arrives at the tubing 92 at other than a 90° angle. Thus, the use of the appropriately sized tubing 92 extending through the reservoir 94, to provide pathways through the chamber 90, ensures that all of the water flowing through the chamber 90 is treated to the required UV dosage of UV light.

The reservoir 94 may but need not fill the chamber 90. The liquid in the reservoir 94 preferably remains out of contact with the UV light source, in the example, the one or more UV light sources are UV LEDs 96. Alternatively, the UV light source may be water-proofed and extend into the reservoir 94.

Referring now to FIGS. 11 and 12, the batch system of any or all of FIGS. 1-3, 5-7 may include a thin plastic removable bladder 110 that is made of material that is highly transmissive to UV light and fits inside of the amplifying chamber 12. In the example, the thin plastic removable bladder 110 is made of plastic, such as PP, and specifically OPP or CPP. In addition, the thin plastic removable bladder 110 has a thickness that is less than or equal to 0.003 of an inch, and may be used in place of the thin plastic film 15 coated onto the inner surface of the chamber 12. The thin plastic removable bladder 110 may be removed from the chamber 12 for cleaning before a next batch of liquid is treated. Also, the removable bladder 110 may be utilized to store the treated water, with another bladder being inserted to treat a next batch, and so forth.

The thin plastic removable bladder 110 may, but need not, be close fitting to the walls of the amplifying chamber 12. If the removable bladder 110 is smaller than the chamber 12, a gap 112 between the walls of the camber 12 and the removable bladder 110 may, but need not, be filled with a liquid that is the same as or has a similar index of refraction as the liquid being treated. In the example, the liquid being treated is water and the gap may be filled with water or distilled water.

The thin plastic removable bladder 110 may, in addition or instead, be utilized in rigid containers utilized for treatment of the water, such as, aluminum bottles, jugs and so forth that have a highly reflective inner surface, to provide a shield from the aluminum walls of the container and thus prevent accidental consumption of aluminum in the treated water. The removable bladder 110 may also be used to store treated water, with another removable bladder 110 inserted for a next batch of water, and so forth. As discussed, any gap between the removable bladder 110 and the chamber 12 walls may, but need not, be filled with the same liquid or a liquid of similar refractive index.

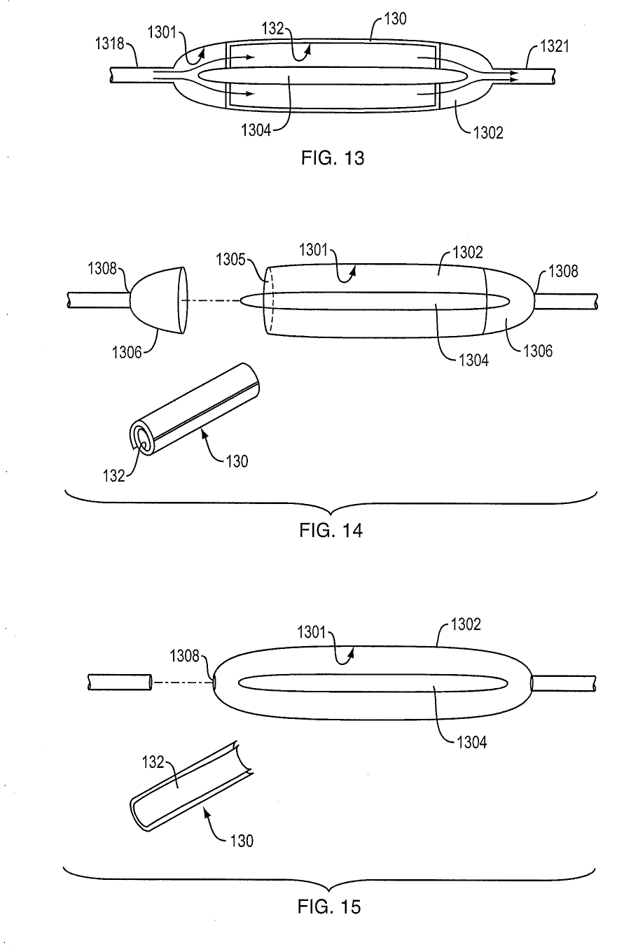

Referring now to FIGS. 13-15, an insert 130 with a highly reflective inner surface 132 may be incorporated into a conventional flow-through chamber 1302 of a water purification system, to provide an inner reflective surface 132 to the flow-through chamber 1302. The lined chamber provides the substantially increased efficiencies, in terms of upgraded performance and/or the use low-power UV light sources, as described above with respect to FIGS. 9-10, as water flows into the chamber 1302 through an ingress 1318 and out of the chamber 1302 through an egress 1321.

The conventional flow-through water purification system typically utilizes a flow-through chamber 1302 that is made of stainless steel, and thus, walls 1301 that have a reflectivity to UV light of approximately 40%. To substantially increase the efficiency of the conventional system, the user introduces the insert 130, to line the chamber 1302 with the highly reflective inner surface 132 of the insert 130. The lined chamber then operates as a flow-through amplifying chamber and the system may utilize a low-power UV light source (not shown) to purify the water at the flow rate of the original system. Alternatively, the system utilizing the lined chamber may operate with the same UV light source 1304 as the original system and purify a greater volume of water by increasing the flow rate through the lined chamber. Alternatively, the flow-through chamber 1302 may be made of aluminum with a coating of thin film plastic, and may but need not be constructed by heat sealing as discussed above. The separate insert 130 would then not be needed.

As shown in FIG. 14, the insert 130 may be a cylinder formed from a relatively thin sheet of aluminum or other material that is highly reflective to the UV light and may be coated with the highly UV-transmissive thin plastic film described above. The insert 130 may be flexible so that the outer diameter of the insert 130 can be made smaller by coiling, for insertion into the chamber 1302. Alternatively, the insert 130 may be rigid and inserted through an opening that is sized to the inner diameter of the chamber 1302.

Referring still to FIG. 14, before use, the insert 130 may, as needed, be coiled to a diameter suitable for introduction to the flow-through chamber 1302 through an opening, such as an open end 1305. The flow-through chamber 1302 may, for example, include one or more end caps 1306 that can be removed for cleaning and the introduction of the insert 130. Accordingly, the insert 130, as necessary, is coiled to a diameter that is slightly smaller the inner diameter of the chamber 1302. Alternatively, the insert 130 may be introduced through an opening 1308 for water flow, and the insert 130 is thus coiled more tightly in order to fit through the smaller opening. The flexible insert 130 is designed to uncoil once the sheet has passed through the opening, and is thus no longer constrained by, the small open end 1305, or the water-flow opening 1308, as appropriate.

As discussed, the ends of the chamber 1302 may be sized such that the removal of the ends results in an opening that has essentially the same dimensions as the inner of the diameter of the chamber 1302. The insert 130 may then be rigid or, if flexible remain uncoiled, such that the insert slips inside the chamber through the open end.

The insert 130, once in place within the chamber 1302, lines the chamber to provide a highly reflective inner surface 132, such that the lined chamber operates essentially as a flow-through amplifying chamber, and thus, provides the efficiencies described above. As discussed, the insert 130 may be coated with a thin plastic film (not shown) that is highly UV transmissive, as described above, to prevent contact between the water and the aluminum. Alternatively, the chamber 130 may be made of aluminum and have a highly UV-transmissive thin plastic coating as described above, and the insert is not needed.

Alternatively, as shown in FIG. 15, the insert 130 may be a thin-walled inflatable shaped bladder that is made of a material that is highly reflective to UV light, such as, for example, aluminum. The insert 130 is introduced into the flow-through chamber 1302 in a deflated state through an opening, such as the water-flow opening 1308. Once inside the chamber, the insert 130 is inflated and essentially conforms to the chamber 1302, to line the chamber with a highly reflective surface 132. The insert 130 that is a shaped bladder may be used, for example, in a system in which the ends of the flow-through chamber 1302 are not removable. The insert 130 may include an adhesive (not shown) on the surface that faces the chamber walls, such that the insert 130 is held in place after inflation.

As described above the insert 130 may have on at least the side forming the highly reflective inner surface 132, the highly UV-transmissive thin plastic film, to prevent contact between the water and the aluminum. The insert 130 may thus be formed using heat sealing.

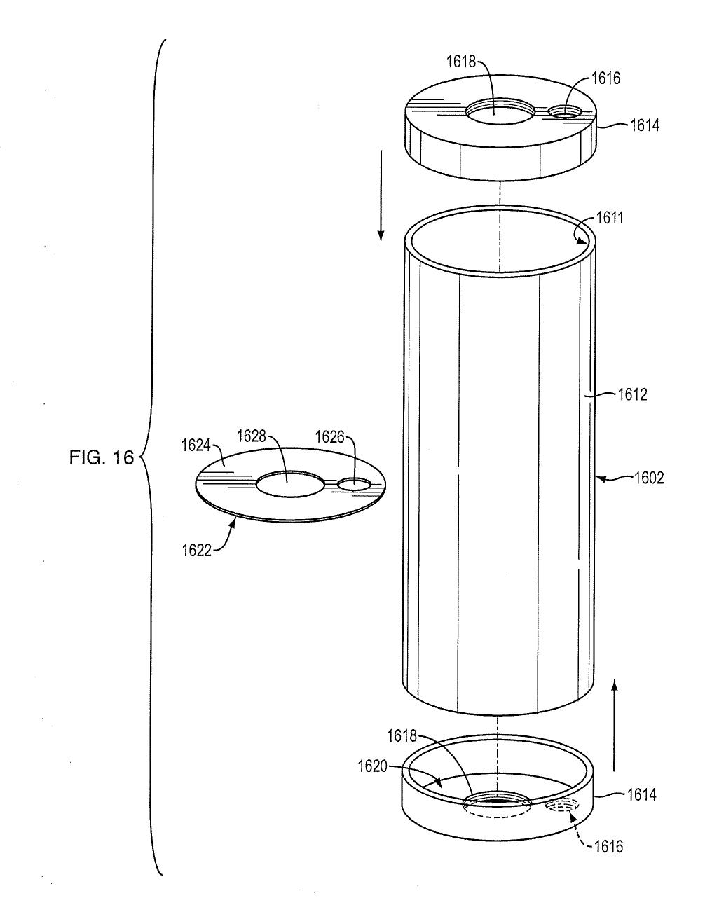

Referring now to FIG. 16, a flow-through system may be configured with an amplifying chamber 1602 that consists of a replaceable cylinder 1612 with a highly reflective interior surface 1611 and removable endcaps 1614 that attach to the cylinder 1612 by, for example, threaded engagement, force fit or other known attachment mechanisms. The removable endcaps 1614 include openings 1616 or transmissive indents (not shown) for the UV light sources and openings 1618 for water inlet and outlet. At appropriate times, the endcaps 1614 are detached from the cylinder 1612 and the cylinder 1612 may then be replaced by another essentially identical cylinder that has a highly reflective interior 1611. The highly reflective interior surface 1611 may be coated with a highly UV-transmissive plastic film, as described above, and the cylinder 1612 may but need not be formed by heat sealing. The inner surface surfaces 1620 of the end caps 1614 may be coated with a reflective material and/or an insert 1622 with a highly reflective inner surface 1624 and cutouts 1626 and 1628 that match the openings 1616 and 1618 in the endcap may be attached to each endcap. The insert 1622 may be permanently or removably attached to the endcap.

For example, the cylinder 1612 may be replaced if the interior surface becomes scratched or otherwise damaged. Alternatively, the inner surface of the cylinder may require cleaning and the cylinder 1612 may be temporarily replaced or, if disposable, permanently replaced, to minimize system downtime.

As discussed above, the highly reflective inner surface 1611 of the cylinder 1612 may be polished aluminum, quartz coated inside or outside with polished aluminum, and so forth. The reflective inner surface 1611 of a replacement cylinder may, but need not, be constructed of the same material as is used in the cylinder 1612 that is being removed from the system.

The replaceable cylinder 1612 may instead include the water inlet and outlet openings 1618, such that the inlet and outlet tubing or piping are disconnected from the cylinder and the endcaps, which are reconfigured without the openings 1618, are removed in order to replace the cylinder.

The foregoing description described certain example embodiments. It will be apparent, however, that other variations and modifications may be made to the described embodiments, with the attainment of some or all of their advantages. For example, although the highly transmissive thin plastic film is illustrated in FIGS. 1 and 2 and the highly UV-transmissive thin plastic removable bladder is illustrated in FIG. 12, it is expressly contemplated that the highly UV-transmissive thin plastic film and/or the highly UV-transmissive thin plastic removable bladder may be utilized in all the systems depicted in FIGS. 1-16. Accordingly, the foregoing description is to be taken only by way of example, and not to otherwise limit the scope of the disclosure. It is the object of the appended claims to cover all such variations and modifications as come within the true spirit and scope of the disclosure.

What is claimed is:

1. A water purification system including
one or more ultraviolet (UV) light sources that provide germicidal UV light to a given amount of fluid contained in an amplifying chamber;
a power source that drives the one or more UV light sources to provide to the fluid a fraction of a total UV energy required to purify the given amount of fluid; and
the amplifying chamber having a highly reflective inner surface that is coated with a thin plastic film that is highly UV-transmissive, the inner surface redirecting through the thin plastic film and through the fluid in substantially all directions the UV light that reaches the reflective inner surface, to provide to the fluid a required dose of UV light to purify the fluid.

2. The water purification system of claim 1 wherein the thin plastic film has a thickness that is less than or equal to 0.003 of an inch, is one of oriented polypropylene or cast polypropylene, and is highly transmissive in the range of 230 nanometers to 300 nanometers.

3. The water purification system of claim 1 further including an opening in the amplifying chamber through which the fluid enters and leaves the amplifying chamber and the one or more UV light sources are suspended into the chamber through the opening.

4. The water purification system of claim 1 wherein the highly reflective inner surface is creased, irregular or both.

5. The water purification system of claim 1 wherein the amplifying chamber is contained within a flexible bladder.

6. The water purification system of claim 1 wherein the amplifying chamber is contained in a wearable bladder.

7. The water purification system of claim 1 further including in the amplifying chamber one or more UV sensors that measure an intensity of the UV light.

8. The water purification system of claim 1 wherein one or more of the UV LEDs operate in a first mode to produce UV light and in a second mode to measure the intensity of the UV light.

9. The water purification system of claim 1 further including within the amplifying chamber one or more plastic tubes that provide pathways for the fluid flowing through the chamber, the plastic tubes being highly UV-transmissive, wherein the plastic tubes have an optical density or index of refraction that is similar to the fluid.

10. The water purification system of claim 9 wherein the amplifying chamber includes a reservoir of a fluid that is the same as or has an index of refraction that is similar to the fluid flowing in the tubes and the tubes extend through the reservoir.

11. The water purification system of claim 1 wherein the highly reflective inner surface is included on an insert that fits into the amplifying chamber.

12. The water purification system of claim 11 wherein the insert is
an inflatable bladder that is provided to the chamber through an opening in a deflated state and inflated within the chamber,
a coiled sheet that is provided to the chamber through an opening and uncoiled within the chamber, or
a sheet that is provided to the chamber through one or more removable end caps.

13. The water purification system of claim 12 wherein one or more of the end caps includes an end cap insert with a reflective inner surface.

14. A water purification system including
one or more ultraviolet (UV) light sources that provide germicidal UV light to a given amount of fluid contained in an amplifying chamber;
a power source that drives the one or more UV light sources to provide to the fluid a fraction of a total UV energy required to purify the given amount of fluid; and
the amplifying chamber housing a thin plastic removable bladder that is highly UV-transmissive and that holds the fluid, and the amplifying chamber having a reflective inner surface that redirects through the fluid in substantially all directions, wherein the UV light passes through the thin plastic removable bladder and reaches the reflective inner surface to provide to the fluid a required dose of UV light to purify the fluid.

15. The water purification system of claim 14 wherein the thin plastic removable bladder has a thickness that is less than or equal to 0.003 of an inch, is one of oriented polypropylene or cast polypropylene, and is highly UV transmissive in the range of 230 nanometers to 300 nanometers.

16. A method of purifying a fluid
providing a given amount of fluid as a batch in or flowing through an amplifying chamber that includes a highly reflective inner surface that is reflective of germicidal ultraviolet (UV) light and is coated with a thin plastic film that is highly UV-transmissive and has a thickness that is that is less than or equal to 0.003 of an inch;
providing to the fluid in the chamber germicidal UV light at an output power that corresponds to a fraction of the UV energy required to purify the given amount of fluid;
repeatedly redirecting simultaneously and in essentially all directions into the fluid, by the highly reflective inner surface of the amplifying chamber, the UV light that passes through the plastic film that is highly UV-transmissive and reaches the reflective inner surface to provide to the fluid a dose of UV light required to purify the fluid.

17. The method of claim 16 wherein the thin plastic film is one of oriented polypropylene or cast polypropylene and is highly transmissive in the range of 230 nanometers to 300 nanometers.

18. The method of claim 16 wherein
the highly reflective inner surface has a reflectance of equal to or above 60% for germicidal UV light, and
the fraction of the UV energy required is equal to or below 30%.

19. The method of claim 16 further comprising providing the reflective inner surface to the amplifying chamber as an insert.

20. The method of claim 16 further comprising:
providing, by one or more UV light emitting diodes (LEDs) operating in a first mode, the UV light; and
measuring, by the one or more UV LEDs operating in a second mode, an intensity of the UV light.
